(19) United States
(12) Patent Application Publication
(10) Pub. No.: US 2018/0219406 A1
(43) Pub. Date: Aug. 2, 2018

(54) ELECTRICAL CHARGING SYSTEMS AND METHOD

(71) Applicant: Jonathan Prieto, San Pedro, CA (US)

(72) Inventor: Jonathan Prieto, San Pedro, CA (US)

(21) Appl. No.: 15/884,324

(22) Filed: Jan. 30, 2018

Related U.S. Application Data
(60) Provisional application No. 62/452,018, filed on Jan. 30, 2017.

(51) Int. Cl. H02J 7/14

(52) U.S. Cl. CPC H02J 7/1423; H02K 53/00

(57) ABSTRACT

An electrical charging system includes at least one motor, an alternator, a first-power-inverter, a battery-charger, and a fuse panel. The at least one battery assembly includes a direct current configured to output a direct current power supply. The at least one motor is configured to receive the direct current power supply from the at least one battery assembly to produce rotative mechanical energy, and the at least one alternator is mechanically coupleable to the at least one motor configured to convert the rotative mechanical energy to direct current electrical energy, and further configured to power the at least one battery assembly via the direct current electrical energy. The first-power-inverter is electrically coupleable to the least one alternator where the battery-charger is electrically coupled and configured to provide a direct current to recharge the at least one battery assembly.

### CROSS-REFERENCE TO RELATED APPLICATION(S)

The present application is related to and claims priority to U.S. Provisional Patent Application No. 62/452,018 filed Jan. 30, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of electrical generator or motor structures of existing art and more specifically relates to motor-generator sets.

### RELATED ART

In today's society most everything is powered by electricity. Electric power is usually produced by electric generators, which generally run on fossil fuels or nuclear energy, but can also be supplied by sources such as batteries, nuclear, or solar energy. Electricity is usually supplied to businesses and homes by the electric power industry through an electric power grid. Electric power is usually sold by the kilowatt hour, which is the product of power in kilowatts multiplied by running time in hours. Electric utilities measure power using an electricity meter, which keeps a running total of the electric energy delivered to a customer. Most electric customers do not have the capability to produce their own power.

The use of fossil fuels and nuclear power plants to create energy can be damaging the environment and the eco-systems. Some have converted to the use of solar energy or hydro-electric energy to help combat the issue; however solar and hydro-electric power is limited to daylight hours and water flow availability. A more efficient method of generating power is needed.

U.S. Pub. No. 2006/0232068 to Abram Ellison relates to perpetual motion energy. The described perpetual motion energy can be used to replace oil, gas, and coal as major sources of energy, by replacing them with perpetual motion energy. One of the many uses for perpetual motion energy is illustrated in an electrical circuit for electric for electric cars or vehicles, showing how: two or more batteries transmit electric current and amps to an Electric Wire Distributor Connector; the distributor sends electric current and amps to an electric motor; the electric motor provides power, and also rotates a generator; the generator charges two or more batteries; the distributor also recharges the batteries by recycling one hundred percent or more energy back to the batteries to produce perpetual motion energy. The batteries do not have to be recharged by any other source. Furthermore, the same circuitry can be applied to in-house electric generators to supply electricity and heat energy to residential and commercial buildings. The use of perpetual motion energy can provide perpetual, efficient, reliable, clean and economical energy through the use of batteries as a power source.

### SUMMARY OF THE INVENTION

In view of the foregoing disadvantages inherent in the known motor-generator sets art, the present disclosure provides a novel electrical charging system and method. The general purpose of the present disclosure, which will be described subsequently in greater detail, is to provide an efficient and effective electrical charging system and method for use.

An electrical charging system and method are disclosed herein. The electrical charging system includes a first-electrical assembly; with the first-electrical assembly including at least one battery assembly, at least one motor, at least one alternator, a first-power-inverter, a battery-charger, and a fuse panel.

The at least one battery assembly includes a direct current configured to output a direct current power supply. The at least one motor is configured to receive the direct current power supply from the at least one battery assembly to produce rotative mechanical energy, and the at least one alternator is mechanically coupleable to the at least one motor configured to convert the rotative mechanical energy to direct current electrical energy, and further configured to power the at least one battery assembly via the direct current electrical energy.

The first-power-inverter is electrically coupleable to the direct current from the at least one alternator where the battery-charger is electrically coupled and configured to provide a direct current to recharge the at least one battery assembly. The fuse panel is configured to provide overload and electrical surge protection to the at least one battery assembly and the other components of the system.

The at least one battery assembly, the at least one motor, and the at least one alternator are configured in series in electrical-communication to provide an electrical-loop to charge the first battery-assembly.

According to another embodiment, a method of use for an electrical charging system is also disclosed herein. The method of use includes a first step, providing an electrical charging system including direct current electricity; a second step, powering a motor via the direct current electricity to provide rotative motion; a third step, rotating an alternator with the rotative motion such that the alternator coverts the rotative energy to direct current electricity; a fourth step, providing the direct current to a first-power-inverter; and a fifth step, charging the battery via the direct current.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an electrical charging system and method, constructed and operative according to the teachings of the present disclosure.

FIG. 1 is a perspective view of the electrical charging system during an ‘in-use’ condition, according to an embodiment of the disclosure.

FIG. 2 is a schematic view of the electrical charging system of FIG. 1, according to an embodiment of the present disclosure.

FIG. 3 is a perspective view of the first-power inverter of FIG. 1, according to an embodiment of the present disclosure.

FIG. 4 is a perspective view of an embodiment of the electrical charging system of FIG. 1, according to an embodiment of the present disclosure.

FIG. 5 is a flow diagram illustrating a method of use for the disclosed electrical charging system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a motor-generator sets and more particularly to an electrical charging system and method as used to improve the longevity, recharging, and production of an electrical storage device (e.g., battery, etc.) during use.

Generally, the present disclosure provides an electrical power generation system that does not require the use of fossil fuels, wind, water, or solar energy. The system comprises a housing, batteries, soundproofing materials, one or more electric-generating motors, motor-connectors, and an electricity discharger. Such an arrangement creates an electrical loop that can power the motor and provide excess electrical power.

The present invention transfers the electrical power to provide 110/120 volts of AC power to homes, appliances, lights, and more. The present invention enables the loop of energy to run for continuous amounts of time to generate power. Other voltages may be used in alternate embodiments.

The present invention is designed for creating ‘free’ energy. The device requires the use of batteries to initially start the system. The batteries feed power to an inverter that converts the direct current voltage to alternating current voltage. The inverter powers up two or more motors that are attached to a belt and rotate together to spin multiple alternators that feed back to the battery to charge it. The other alternators can be used to power up their own inverters, which can be used for appliances such as refrigerators, microwaves, and more.

Embodiments may include five or more electric generating motors. Soundproofing materials may be included. The exact specifications may vary and energy may be added to the system from external sources.

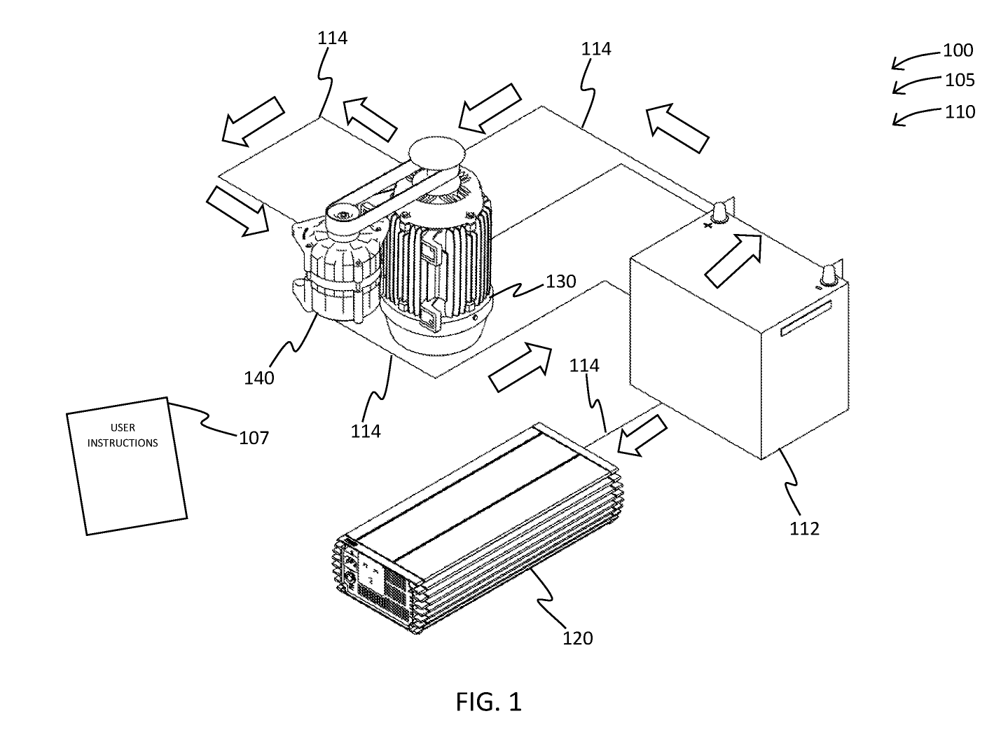

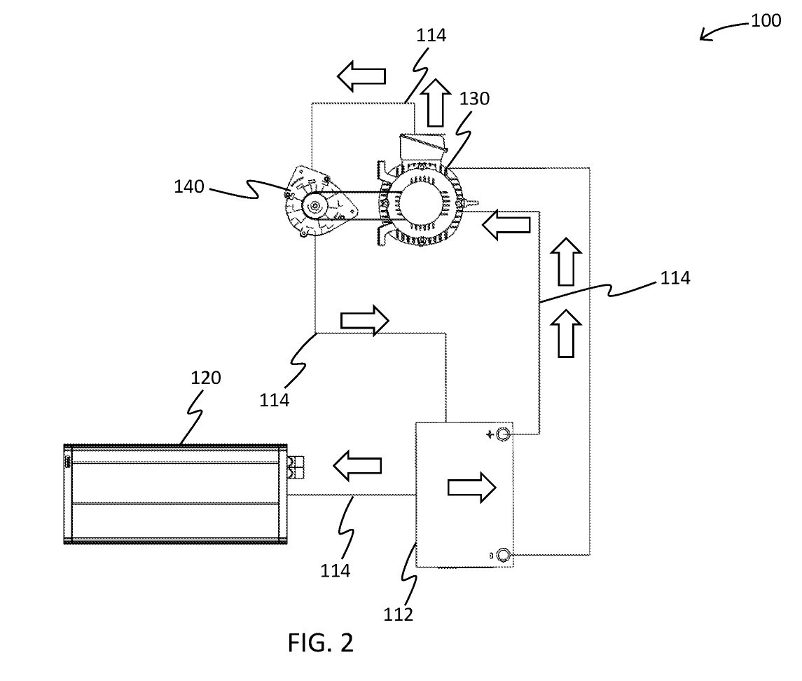

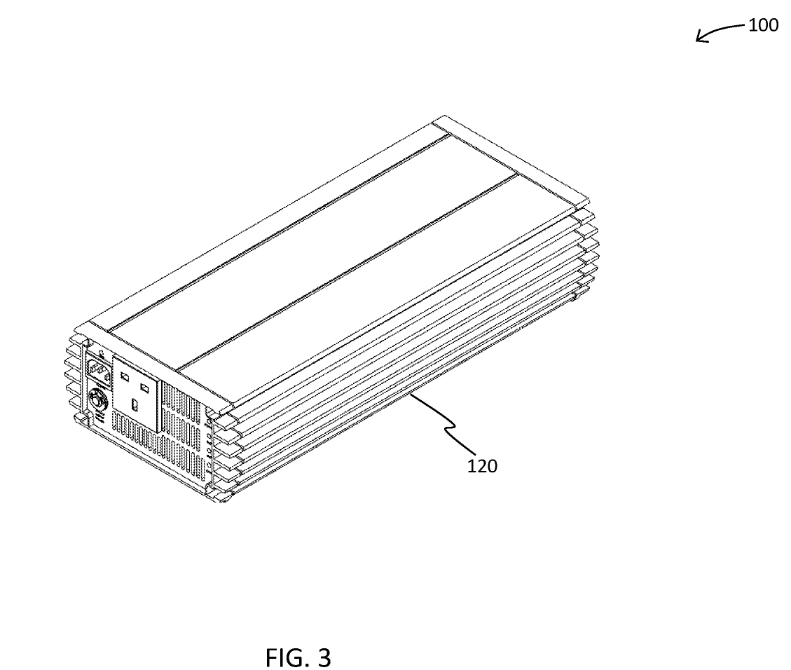

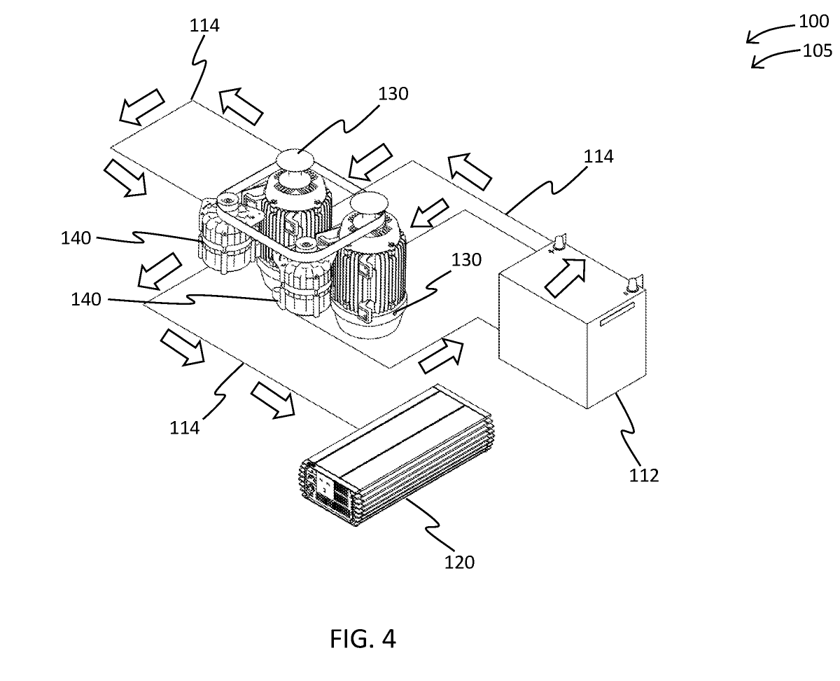

Referring now more specifically to the drawings by numerals of reference, there is shown in FIGS. 1-4, various views of an electrical charging system 100.

FIGS. 1-4 show an electrical charging system 100 during an ‘in-use’ condition 50, according to an embodiment of the present disclosure. Here, the electrical charging system 100 may be beneficial for use by a user to power electrical appliances as well as recharging an electrical storage device such as a battery. As illustrated, the electrical charging system 100 may include first-electrical assembly 110. First-electrical assembly 110 may include at least one battery assembly 112, at least one motor 130, at least one alternator 140, and a first-power-inverter 120. At least one battery assembly 112, at least one motor 130, at least one alternator 140 may be configured in series in electrical-communication to provide an electrical-loop to charge first battery-assembly 112.

At least one battery assembly 112 may include direct current 114 configured to output a direct current 114 power supply. At least one motor 130 may be configured to receive direct current 114 power supply from at least one battery assembly 112 to produce rotative mechanical energy. At least one alternator 140 may be mechanically coupleable to at least one motor 130 and configured to convert the rotative mechanical energy to direct current 114 electrical energy, where at least one alternator(s) 140 may be further configured to power at least one battery assembly 112 via direct current electrical energy 114. Also, first-power-inverter 120 may be electrically coupleable to direct current 114 from at least one alternator 140.

Embodiments may also include battery-charger (not shown) electrically coupled and configured to provide direct current 114 to recharge the at least one battery assembly 112. Further embodiments may also include fuse panel (not shown) configured to provide overload protection to at least one battery assembly 112. Those with ordinary skill in the art will now appreciate that upon reading this specification and by their understanding the art of electricity and electrical components, distribution as described herein, methods of use will be understood by those knowledgeable in such art.

System 100 may include a second-battery assembly arranged electrically in parallel with first-battery assembly 112 or may additionally/alternately include second-battery assembly arranged electrically in series with said first-battery assembly 112. Embodiments may include additional battery assemblies depending upon specifications and user preferences.

Some embodiments may further include second-alternator powered by at least one motor. Embodiments may also include including a third-alternator powered by said rotative mechanical energy from said at least one motor 130. Additional embodiments may include two motors 130 mechanically coupleable to at least one alternator 140.

Battery-charger is further configured to receive a 120 volt outside electrical source configured to recharge said at least one battery assembly. Also, system 100 includes a second-electrical assembly such that system 100 is configured to recharge a second battery-assembly. first-electrical assembly 112 and said second-electrical assembly are in electrical communication with each other. Upon reading this specification, it should be appreciated that, under appropriate circumstances, considering such issues as user preferences, design preference, structural requirements, marketing preferences, cost, available materials, technological advances, etc., other electrical arrangements such as, for example, multiple systems, etc., may be sufficient.

Direct current may include 114, but not be limited to 12 volts, 24 volts, 300 volts or any combination thereof. Alternating current may include, but not be limited to 120, 240, and/or 480 volts.

According to one embodiment, electrical charging system 100 may be arranged as a kit 105. In particular, electrical charging system 100 may further include a set of instructions 107. The instructions 107 may detail functional relationships in relation to the structure of electrical charging system 100 such that electrical charging system 100 can be used, maintained, or the like, in a preferred manner.

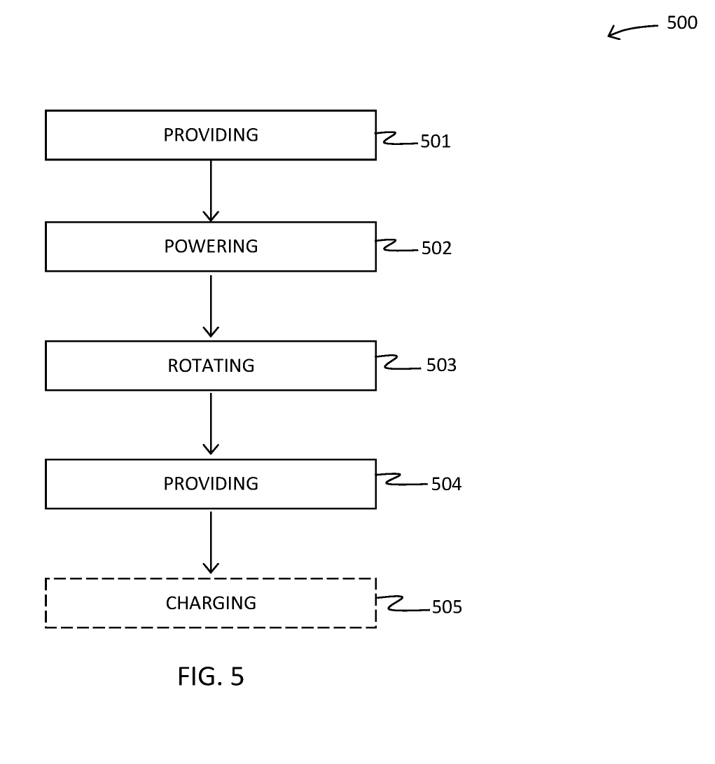

FIG. 5 is a flow diagram illustrating a method of use for an electrical charging system 500, according to an embodiment of the present disclosure. In particular, method of use for an electrical charging system 500 may include one or more components or features of electrical charging system 100 as described above. As illustrated, method of use for an electrical charging system 500 may include the steps of: step one 501, providing electrical charging system including direct current 114 electricity; step two 502, powering motor 130 via direct current 114 electricity to provide rotative motion; step three 503, rotating alternator 140 with the rotative motion such that alternator 140 coverts the rotative energy to direct current 114 electricity; step four 504, providing direct current 114 electricity to first-power-inverter 120; and step five 505, charging a battery 112 via direct current 114.

It should be noted that step five 505 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods of use for an electrical charging system, taking power from or adding power to, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An electrical charging system, the system comprising:
a first-electrical assembly, said first-electrical assembly including;
at least one battery assembly, said at least one battery assembly including a direct current configured to output a direct current power supply;
at least one motor, said at least one motor configured to receive said direct current power supply from said at least one battery assembly to produce rotative mechanical energy;
at least one alternator, said at least one alternator mechanically coupleable to said at least one motor and configured to convert said rotative mechanical energy to direct current electrical energy, said at least one alternators further configured to power the at least one battery assembly via the direct current electrical energy; and
a first-power-inverter, said first-power-inverter electrically coupleable to said direct current from said at least one alternator; and
wherein said at least one battery assembly, said at least one motor, said at least one alternator are configured in series in electrical-communication to provide an electrical-loop to charge said first battery-assembly battery.

2. The system of claim 1, further including a battery-charger electrically coupled and configured to provide a direct current to recharge said at least one battery assembly.

3. The system of claim 1, further including a fuse panel configured to provide overload protection to said at least one battery assembly.

4. The system of claim 1, further including a second-battery assembly arranged electrically in parallel with said first-battery assembly.

5. The system of claim 1, further including a second-battery assembly arranged electrically in series with said first-battery assembly.

6. The system of claim 1, further including a second-alternator powered by said at least one motor.

7. The system of claim 1, further including a third-alternator powered by said rotative mechanical energy from said at least one motor.

8. The system of claim 1, further including two said motors mechanically coupleable to said at least one alternator.

9. The system of claim 1, wherein said battery-charger is further configured to receive a 120 volt outside electrical source configured to recharge said at least one battery assembly.

10. The system of claim 1, wherein said system includes a second-electrical assembly such that said system is configured to recharge a second battery-assembly.

11. The system of claim 10, wherein said first-electrical assembly and said second-electrical assembly are in electrical communication with each other.

12. The system of claim 1, wherein said alternating current includes a 240 volt current.

13. The system of claim 1, wherein said alternating current includes a 120 volt current.

14. The system of claim 1, wherein said direct current of said system includes 300 volts.

15. The system of claim 1, wherein said direct current of said system includes 12 volts.

16. The system of claim 1, wherein said direct current of said system includes 24 volts.

17. An electrical charging system, the system comprising:
a first-electrical assembly, said first-electrical assembly including;
at least one battery assembly, said at least one battery assembly including a direct current configured to output a direct current power supply;
at least one motor, said at least one motor configured to receive said direct current power supply from said at least one battery assembly to produce rotative mechanical energy;
at least one alternator, said at least one alternator mechanically coupleable to said at least one motor and configured to convert said rotative mechanical energy to direct current electrical energy, said at least one alternators further configured to power the at least one battery assembly via the direct current electrical energy;
a first-power-inverter, said first-power-inverter electrically coupleable to said direct current from said at least one alternator;
a battery-charger electrically coupled and configured to provide a direct current to recharge said at least one battery assembly;
a fuse panel configured to provide overload protection to said at least one battery assembly; and
wherein said at least one battery assembly, said at least one motor, said at least one alternator are configured in series in electrical-communication to provide an electrical-loop to charge said first battery-assembly.

18. The system of claim 17, further comprising set of instructions; and
wherein the system is arranged as a kit.

19. A method of use for an electrical charging system, the method comprising the steps of:
providing a electrical charging system including direct current electricity;
powering a motor via said direct current electricity to provide rotative motion;
rotating an alternator with said rotative motion such that said alternator coverts said rotative energy to direct current electricity; and
providing said direct current to a first-power-inverter.

20. The method of claim 19, further comprising the steps of
charging said battery via said direct current.
